(19) United States
(12) Patent Application Publication
(10) Pub. No.: US 2024/0088605 A1
(43) Pub. Date: Mar. 14, 2024

(54) MODULAR CABLE EXIT ASSEMBLY

(71) Applicants: TE Connectivity Italia Distribution S.r.l., Torino (IT); TE Connectivity Germany GmbH, Bensheim (DE)

(72) Inventors: Carla Castagno, Torino (IT); Patrick Wrobel, Bensheim (DE); Uwe Siegel, Bensheim (DE); Carsten Lendwei, Bensheim (DE)

(21) Appl. No.: 18/462,700

(22) Filed: Sep. 7, 2023

(30) Foreign Application Priority Data
Sep. 9, 2022 (EP) 22194933.2

(51) Int. Cl. H01R 13/58

(52) U.S. Cl. CPC H01R 13/582

(57) ABSTRACT

A modular cable exit assembly includes a receptacle housing and a cable exit adapter, wherein the receptacle housing includes one or more contact cavities for electrical terminals for connection to at least one cable and a coupling portion, and wherein the cable exit adapter includes a body and an exit collar for accommodating a portion of said at least one cable coming out of the receptacle housing. The body and the coupling portion are configured to be coupled by a snap-fit connection. A method for assembling the modular cable exit assembly includes assembling the receptacle housing and the cable exit adapter by coupling the body and the coupling portion by a snap-fit connection.

### CROSS REFERENCE TO RELATED APPLICATIONS

This application claims the benefit of EP Application No. 22194933.2, filed on 9 Sep. 2022, the subject matter of which is herein incorporated by reference in its entirety.

### BACKGROUND OF THE INVENTION

The subject matter herein relates to cable connections.

It is known to the state of the art to produce a cable exit assembly being made as a single piece. That is, having a receptacle housing with an integrated cable exit. The cable exit may be oriented in different ways with respect to the main body of the receptacle housing depending on the specific customer needs and may have different designs and shapes. For instance, it may form an angle of 45° or 90° or 180° with respect to the main body of the receptacle housing. A cover may be further provided to the cable exit assembly to protect the terminals accommodated in the receptacle housing.

The single body cable exit assemblies are generally produced by means of a molding process. However, molding cable exit assemblies having a single body present several disadvantages. As a first point, complex tools are needed to mold the single piece cable exit assemblies, due to the complex shape to be molded. Moreover, it is necessary to inject the molding material into the mold with high pressure in order to form the integrated cable exit protruding from the receptacle housing. Furthermore, warpage issues are encountered when producing the 180° cable exit, which result in difficulties in keeping the correct position of the cable exit and in mounting the cover at a later step of the assembly. Finally, another disadvantage of forming a cable exit assembly having a single piece is that it is not possible to form retention ribs for the positioning of a corrugated tube on cable exits that form an angle of 45° or 180°. This results in a lower retention of the corrugated tube in the receptacle housing and in a high probability of failing customer tests. In general, the integrated solution has design limitations of the cable exit due to the molding process.

A need exists for a cable exit assembly which solves these and other problems of the prior art.

### BRIEF DESCRIPTION OF THE INVENTION

One or more embodiments of the subject matter herein provide a modular cable exit assembly, wherein the two main components, (for example, the receptacle housing and the cable exit adapter), are made as two distinct pieces and are further assembled.

According to an aspect, a modular cable exit assembly is provided including a receptacle housing having one or more contact cavities for electrical terminals configured to be connected to at least one cable and a cable exit adapter including an exit collar for accommodating a portion of the at least one cable coming out of the receptacle housing. The modular cable exit assembly is characterized in that, the receptacle housing further includes a coupling portion and the cable exit adapter further includes a body, wherein the coupling portion and the body are configured to be coupled by a snap-fit connection.

An advantage of this configuration is that the production process is simplified and sped-up and production costs are reduced. When exploiting molding techniques for producing the modular cable exit assembly of the invention, two different molding kits may be used: one for forming the receptacle housing and one for forming the cable exit adapter. The molding kit for forming the receptacle housing may be standardized and may be used for all kinds of modular cable exit assemblies. On the other hand, the molding kit for the cable exit adapter may be adapted to the desired orientation and configuration of the cables exiting the receptacle housing and to the specific customer's needs. Accordingly, embodiments herein ensure more versatility in creating new customized variants of cable exits. Moreover, since the molding kits for the cable exit adapters are simple and compact, there is no need to inject a molding material in the mold with high pressure. Therefore, the warpage issues and the difficulties in keeping the correct position of the cable exit are overcome. Furthermore, embodiments herein allow forming retention ribs for corrugated tubes on all kinds of cable exit adapters, since they can be easily added to the inner surface of the cable exit adapters.

Various embodiments of the cable exit adapter include a component for accommodating and guiding, along a predefined direction, a portion of one or more cables that come out of the receptacle housing.

In various embodiments, the receptacle housing may be a receptacle housing of a connector, for instance, of the female or male type. The receptacle housing may include one or more contact cavities for electrical terminals configured to be connected to one or more cables for electrical connection. For example, the one or more cables may be crimped to the electrical terminals.

In various embodiments, the cable exit adapter and the receptacle housing are made as two distinct components and can be coupled by a snap-fit connection, by snapping the body of the cable exit adapter into the coupling portion of the receptacle housing. The advantage of exploiting a snap-fit connection is that the two mating components are attached by simply pushing together the two coupling portions and there is no need to employ additional parts, such as nails or screws. Therefore, the whole process is fast and simple.

A snap-fit connection can be a multiple-use or a permanent connection. In a multiple-use snap-fit connection, the body and the coupling portion are reversibly coupled, so that the cable exit adapter can be removed from the receptacle housing. In a permanent snap-fit connection, the body and the coupling portion are irreversibly coupled, so that the cable exit adapter is permanently coupled to the receptacle housing. Attempting to undo a permanent snap-fit connection can result in breaking of the pieces.

In various embodiments, a snap-fit connection including a cantilever is exploited.

In various embodiments, a modular cable exit assembly is provided, wherein a plurality of first guides is formed on the body of the cable exit adapter and a plurality of second guides is formed on the coupling portion and the plurality of first guides is configured to fit into mating second guides. The advantage of such configuration is that alignment of the receptacle housing and of the cable exit adapter can be easily obtained by aligning the first guides of the body of the cable exit adapter and the mating second guides of the coupling portion and by sliding the two components, one on the other along the mating guides, until the coupling elements are coupled by the snap-fit connection.

In various embodiments, a modular cable exit assembly is provided, wherein the cable exit adapter includes one or more retention hooks suitable for securing the cable exit adapter to a retention wall of the receptacle housing. The advantage of such configuration is that, after assembly of the modular cable exit assembly, the receptacle housing and the cable exit adapter are fixed and secured to each other by the retention hooks, which are engaged to a portion of the retention wall formed on the receptacle housing.

In various embodiments, a modular cable exit assembly is provided, wherein the body of the cable exit adapter includes a cantilever and the coupling portion includes a seat and the cantilever is configured to fit into the seat. The advantage of such configuration is that the cantilever is snapped onto a corresponding seat realized on the coupling portion, so as to form a snap-fit connection and keep the two components securely assembled together. The snap-fit connection including a cantilever is a simple and efficient connection, because it does not need additional parts such as nails or screws.

Optionally, the cantilever design can be for multiple use or for permanent use. A multiple use cantilever has a lever or pin that can be pushed in order to undo the snap-fit connection. On the other hand, on a permanent snap-fit cantilever, there is no lever or pin and an attempt to undo the permanent snap-fit can result in the piece breaking.

Optionally, the cantilever may further provided with a stopper in order to prevent the snap-fit from breaking and to avoid that, in an attempt to undo the snap-fit connection, the cantilever is hyperextended past its breaking point.

In various embodiments, a modular cable exit assembly is provided, wherein the exit collar is slanted by an angle of 45° with respect to a plane passing through the coupling portion. The advantage of such configuration is that it ensures that the one or more cables coming out of the receptacle housing form an angle of 45° with respect to the main body of the receptacle housing. This particular orientation of the cables may be useful for forming additional electrical connections to other electrical components.

In various embodiments, a modular cable exit assembly is provided, wherein the exit collar is slanted by an angle of 90° with respect to a plane passing through the coupling portion. The advantage of such configuration is that it ensures that the one or more cables coming out of the receptacle housing form an angle of 90° with respect to the main body of the receptacle housing. This particular orientation of the one or more cables may be useful for establishing additional electrical connections to other electrical components.

In various embodiments, a modular cable exit assembly is provided, wherein the exit collar is parallel to a plane passing through the coupling portion. The advantage of such configuration is that it ensures that the one or more cables coming out of the receptacle housing are parallel to a plane passing through the coupling portion of the receptacle housing. This particular orientation may be useful for establishing additional electrical connections to other electrical components. Moreover, this particular orientation may be useful in case of electrical connections with space limitations.

In various embodiments, a modular cable exit assembly is provided, wherein the cable exit adapter is removeably coupled to the receptacle housing. The advantage of such configuration is that it allows interchangeability of the cable exit adapters according to the particular customers' requests. For instance, the cable exit adapter can be safely removed from the receptacle housing without being damaged and without breaking the receptacle housing. For instance, the cable exit adapter can be replaced with a different cable exit adapter having a different cable exit orientation. In this way, it is possible to keep the same receptacle housing and the electrical contacts formed therein and to change the orientation of the exiting cables.

In various embodiments, a modular cable exit assembly is provided, wherein the modular cable exit assembly further includes a cover element for covering the receptacle housing. The advantage of such configuration is that the one or more terminals for electrical contacts accommodated in the receptacle housing are covered and protected by the cover.

In various embodiments, a method for assembling a modular cable exit assembly, such as the ones described above, is provided including the steps of providing the receptacle housing, providing the cable exit adapter, and assembling the receptacle housing and the cable exit adapter by coupling the body and the coupling portion by a snap-fit connection. The advantage of such solution is that the receptacle housing and the cable exit adapter may be produced as single pieces and may be further assembled so as to form a modular cable exit assembly that can be used in complex electrical connectors.

The snap-fit connection may ensure that the two components are coupled by simply pushing the body of the cable exit adapter into the coupling portion of the receptacle housing. There is no need to use nails, screws or other loose parts for the assembly and the process is fast and simple.

In various embodiments, the method for assembling the modular cable exit assembly includes the step of aligning first guides of the cable exit adapter with mating second guides of the receptacle housing and sliding the first guides along the second guides during coupling of the body and the coupling portion. The advantage of such configuration is that the correct positioning of the cable exit adapter and the receptacle housing is ensured by aligning the first guides with the second guides. In this way, by sliding the cable exit adapter on the receptacle housing along the corresponding guides, it is endured that the body of the cable exit adapter and the coupling portion of the receptacle housing are in the correct reciprocal position for the snap-fit connection.

In various embodiments, the method for assembling the modular cable exit assembly includes the step of inserting a cantilever of the cable exit adapter into a seat on the coupling portion. The advantage of such configuration is that it exploits a snap-fit connection including a cantilever so as to form a stable and secure connection between the two components. The cantilever design can be for multiple use or for permanent use.

### BRIEF DESCRIPTION OF THE DRAWINGS

FIG. 1 schematically illustrates a prior art electrical connector having a receptacle housing with an integrated cable exit.

FIG. 2A schematically illustrates a receptacle housing and a cable exit adapter in accordance with embodiments herein.

FIG. 2B schematically illustrates a modular cable exit assembly including a receptacle housing and a cable exit adapter in accordance with embodiments herein.

FIG. 3 schematically illustrates a modular cable exit assembly including a receptacle housing and a cable exit adapter in accordance with embodiments herein.

FIG. 4 schematically illustrates a modular cable exit assembly including a receptacle housing and a cable exit adapter in accordance with embodiments herein.

FIG. 5 schematically illustrates a modular cable exit assembly including a receptacle housing and a cable exit adapter in accordance with embodiments herein.

FIG. 6 schematically illustrates a back view of a step of assembly of a receptacle housing and a cable exit adapter in accordance with embodiments herein.

FIG. 7 schematically illustrates a front view of a step of assembly of a receptacle housing and a cable exit adapter in accordance with embodiments herein.

FIG. 8 schematically illustrates a side view of a modular cable exit assembly including a receptacle housing and a cable exit adapter in accordance with embodiments herein.

FIG. 9 schematically illustrates a modular cable exit assembly including a receptacle housing, a cable exit adapter and a cover for the receptacle housing and a corrugated tube in accordance with embodiments herein.

### DETAILED DESCRIPTION OF THE INVENTION

In the following, the subject matter herein=is described with reference to particular embodiments as shown in the enclosed drawings. Nevertheless, the invention is not limited to the particular embodiments described in the following detailed description and shown in the figures, but, instead, the embodiments described simply exemplify several aspects of the invention, the scope of which is defined by the appended claims.

It is to be understood that the words “top”, “up”, “bottom”, “down”, “front”, “rear” and variations thereon are used with reference to the orientation of the components as shown in the enclosed figures; however, they do not intend to define a preferred orientation of the components.

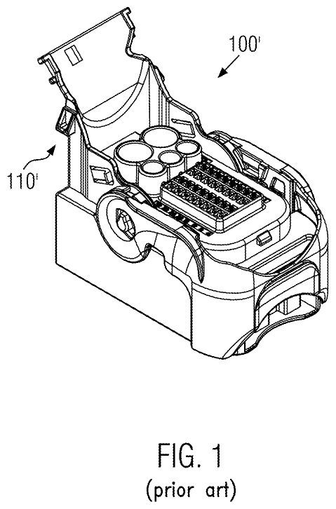

FIG. 1 schematically illustrates a cable exit assembly 100′ according to the prior art, wherein the receptacle housing has an integrated cable exit 110′. The cable exit assembly 100′ may be used to control the exit directions of one or more cables connected to the terminals accommodated in the electrical connector. For example, in FIG. 1, the integrated cable exit 110′ has a cable exit direction of 45° with respect to the main body of the receptacle housing.

The cable exit assembly 100′ according to the prior art is generally produced by means of a molding process. However, the molding process for producing a cable exit assembly 100′ with an integrated cable exit 110′ is complex and presents several drawbacks.

For example, with reference to the orientation of the cable exit assembly 100′ shown in FIG. 1, the molding material for forming the cable exit assembly 100′ would be injected from the bottom during a molding process. Accordingly, it would be necessary to inject the molding material with high pressure in order to produce the upper part of the cable exit assembly 100′, for example for producing the integrated cable exit 110′. However, it is difficult to control the high-pressure molding material.

Moreover, when producing cable exit assemblies 100′ having an integrated cable exit 110′ perpendicular to the plane on which the cable exit assembly 100′ sits, warpage issues may be encountered during the molding process. Accordingly, it might be difficult to form the cable exit having the correct exit position.

Furthermore, as it can be clearly seen in FIG. 1, the structure of the cable exit assembly 100′ made as a single piece is complex, as it includes a main body with protruding parts. Therefore, the mold used during the molding process must have a complex shape and it is difficult to produce all the details of the elements of the final product. For example, it is not possible to form retention ribs for corrugated tubes in the cable exit assemblies 100′ having an integrated cable exit 110′ oriented at 45° or perpendicular to the support surface of same, due to construction issues. Therefore, the cable exit assembly 100′ provides less retention for the corrugated tube and has higher probability of failing customer tests.

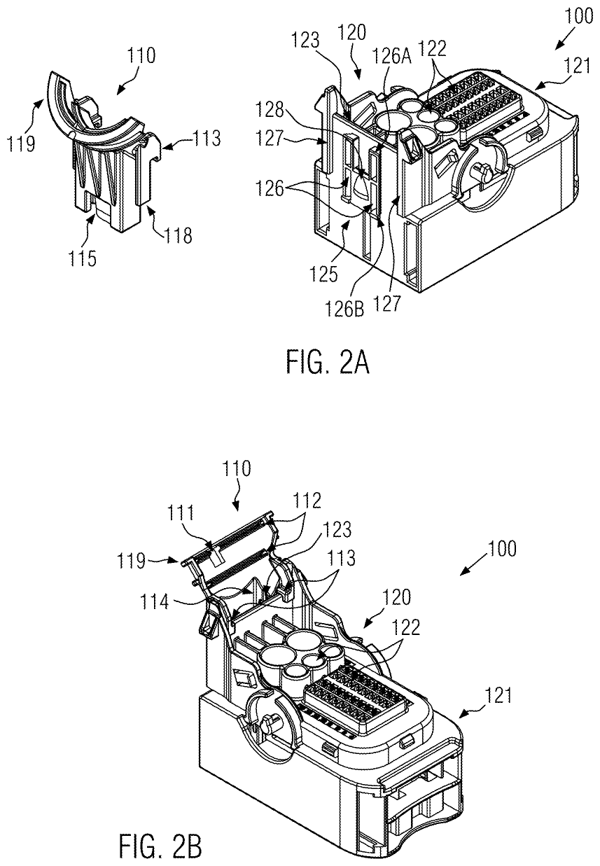

FIG. 2A schematically illustrates a modular cable exit assembly 100 according to an exemplary embodiment. In FIG. 2A, it is possible to see that the receptacle housing 120 and the cable exit adapter 110 are produced as independent components, such as being formed as single pieces. The cable exit adapter 110 and the receptacle housing 120 are subsequently assembled together to form the modular cable exit assembly 100 which is schematically illustrated in FIG. 2B.

The modular cable exit assembly 100 presents several advantages with respect to the prior art. As a first point, since the cable exit adapter 110 and the receptacle housing 120 are produced as independent components, the molding kits are simplified. For instance, a first kit can be used for molding the receptacle housing 120 and a second kit can be used for molding the cable exit adapter 110. The first molding kit for forming the receptacle housing 120 may be standardized and may be used for all kinds of modular cable exit assemblies 100. On the other hand, the second molding kit for the cable exit adapter 110 may be adapted to the desired orientation and configuration of the cables exiting the receptacle housing and to the specific customer's needs. Moreover, the cable exit adapter 110 allows overcoming the issues of the high pressure molding material for the cable exit adapter, because each molding kit is simplified and is made more compact. Accordingly, there is no need to inject molding material at high pressure. Furthermore, it is possible to form retention ribs for the corrugated tubes on the cable exit adapter 110 by simply adapting the shape of the mold.

In view of the above, it appears that the present solution is more versatile for creating new customized cable exit assemblies 100. It also simplifies and improves the molding process and reduces production costs.

As it can be seen in FIG. 2A, the cable exit adapter 110 includes a body 118 and an exit collar 119 for accommodating a portion of one or more cables coming out of the receptacle housing 120. On the outer portion of the exit collar 119, a cable tie may be provided. The cable exit adapter 110 further includes two retention hooks 113, which are configured to secure the cable exit adapter 110 to the retention wall of the receptacle housing 120, as it will be described in the following. Moreover, the cable exit adapter 110 includes a tab or cantilever 115, which is used as a snap-fit connection with the receptacle housing 120.

As it can be seen in detail in FIG. 2B, the cable exit adapter 110 includes a slot 111, which may be used to accommodate a cable tie in order to bind together one or more cables coming out of the receptacle housing 120. The slot 111 is used when no corrugated tube is used and there is a plurality of cables. In that case, a cable tie is passed through the slot 111 and fixed on one of the two sides to the outer part of the exit collar 119. Moreover, two retention ribs 112 are formed on the inner surface of the cable exit adapter 110, in order to provide a retention surface for a corrugated tube that may accommodate the one or more cables coming out of the receptacle housing 120. The inner area with the retention ribs 112 can be customized according to customer needs. Furthermore, the cable exit adapter 110 includes a set of guides 114, which can be aligned with corresponding guides formed on the receptacle housing 120, so as to favour sliding and coupling of the two components, as it will be described in the following.

The receptacle housing 120 includes a main body 121 on which one or more contact cavities 122 for accommodating corresponding electrical terminals are formed. The terminals provided in the contact cavities 122 are connected to one or more corresponding cables which are then partially accommodated in the exit collar 119 of the cable exit adapter 110 and are directed outside the modular cable exit assembly 100 for forming other electrical connections. Preferably, the terminals are already crimped to the one or more cables when they are put inside the receptacle housing 120.

The main body 121 of the receptacle housing 120 extends between a front surface and a rear service. On the rear surface, as it can be seen in FIG. 2A, a coupling portion 125 for forming a snap-fit connection with the cable exit adapter 110 is formed. The coupling portion 125 includes two set of guides 126 and 127 for guiding the positioning of the cable exit adapter 110 during coupling of the two components. The two sets of guides include inner guides 126 and outer guides 127. Each guide 126 extends between a first extremity 126A and a second extremity 126B. Moreover, the coupling portion 125 includes a seat 128 for engaging the tab or cantilever 115 of the cable exit adapter 110. The rear surface of the receptacle housing 120 forms a retention wall 123.

For instance, the receptacle housing 120 may be the receptacle housing of a female connector configured to form an electrical connection with a mating male connector. Alternatively, the receptacle housing 120 may be the receptacle housing of a male connector configured to form an electrical connection with a mating female connector.

As it can be seen in FIG. 2B, when the cable exit adapter 110 and the receptacle housing 120 are assembled to form the modular cable exit assembly 100, the body 118 of the cable exit adapter 110 (not visible in the figure) is inserted into the coupling portion 125 of the receptacle housing 120 (not visible in the figure). The exit collar 119 protrudes from the receptacle housing 120 for guiding and directing the exit of the one or more cables connected to the terminals of the contact cavities 122. For instance, in the configuration of FIG. 2B, the cable exit adapter 110 is a 45° cable exit adapter, because the exit collar 119 forms an angle of 45° with respect to the plane including the coupling portion 125. In other words, the exit collar 119 of the cable exit adapter 110 is slanted by an angle of 45° with respect to the rear surface of the receptacle housing 120 including the retention wall 123.

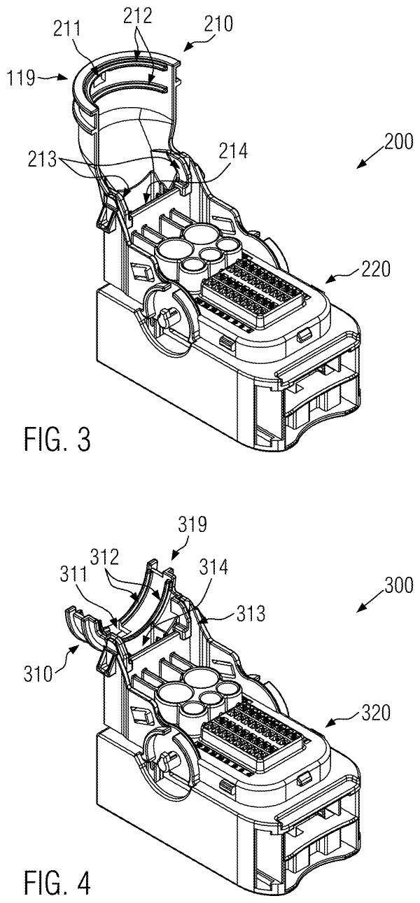

FIG. 3 schematically illustrates a modular cable exit assembly 200, according to an exemplary embodiment. In the modular cable exit assembly 200 of FIG. 3, the receptacle housing 220 corresponds to the receptacle housing 120 described with reference to FIGS. 2A and 2B. The cable exit adapter 210 of FIG. 3 corresponds to the cable exit adapter 110 described in FIGS. 2A and 2B, but it differs from same in the orientation of the exit collar 219 with respect to the main body of the receptacle housing 220. The cable exit adapter 210 is a 180° cable exit adapter and the exit collar 219 is parallel to the rear surface of the receptacle housing 220 including the coupling portion (not visible in FIG. 3).

FIG. 4 schematically illustrates a modular cable exit assembly 300 according to an exemplary embodiment. The receptacle housing 320 shown in FIG. 4 corresponds to the receptacle housing 120 described with reference to FIGS. 2A and 2B. The cable exit adapter 310 of FIG. 4 differs from the cable exit adapter 110 of FIGS. 2A and 2B in the orientation of the exit collar 319. The cable exit adapter 310 is a 90° cable exit adapter, i.e. it is slanted by an angle of 90° with respect to the plane including the coupling portion of the receptacle housing 320 (not visible in FIG. 4).

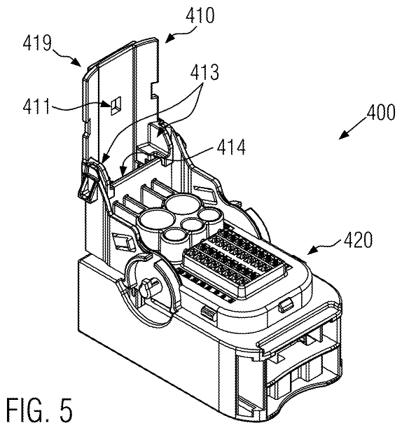

FIG. 5 schematically illustrates a modular cable exit assembly 400 according to an exemplary embodiment. In the modular cable exit assembly 400, the receptacle housing 420 corresponds to the receptacle housing 120 described with reference to FIGS. 2A and 2B. The cable exit adapter 410 corresponds to the cable exit adapter 110 and it differs from same in the orientation of the exit collar 419. The exit collar 419 is parallel to the plane passing through the coupling portion of the receptacle housing 420 (not visible in FIG. 5) and it is substantially flat. This particular configuration of the cable exit adapter 410 is designed so as to fit to connector configurations wherein, due to space limitation, the cables connected to the receptacle housing 410 must have an exit direction parallel to the rear surface of the receptacle housing 420 and must occupy as little space as possible.

FIGS. 3, 4, and 5 also show that the cable exit adapters 210, 310 and 410 include retention hooks 213, 313 and 413, respectively, which have the same function of the retention hooks 113 shown in FIGS. 2A and 2B. Moreover, FIGS. 3, 4 and 5 show the slots 211, 311 and 411 formed, respectively, in the cable exit adapters 200, 300 and 400, which have the same function of the slot 111 of the cable exit adapter 110.

Finally, in FIGS. 3, 4 and 5, it is possible to see that the cable exit adapters 210, 310 and 410 include first guides 214, 314 and 414, respectively, which have the same function of the first guides 114 described with reference to the cable exit adapter 110.

It is clear that the shape and the configuration of the cable exit adapter may vary and may be adapted to the specific use of the electrical connectors including the one or more cables connected to the terminals of the receptacle housings.

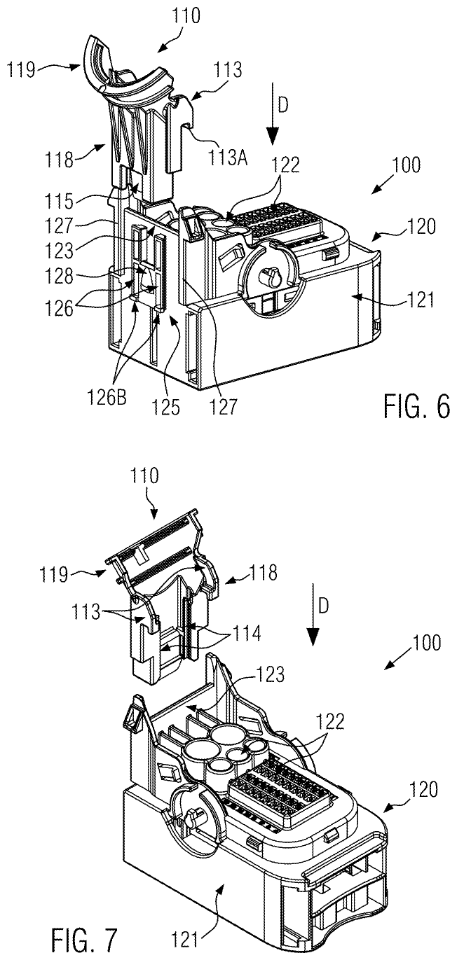

With reference to FIGS. 6 to 8, a method for assembling a modular cable exit assembly is described. It is to be understood that, even if the assembly method is described with reference to the modular cable exit assembly 100, the same method also applies to the modular cable exit assemblies 200, 300 and 400.

The cable exit adapter 110 can be easily and quickly assembled to the receptacle housing 120 by snapping the two components together at the snap fit connection portions. As a first step, the cable exit adapter 110 is positioned above the receptacle housing 120 in correspondence with the coupling portion 125. The first guides 114 of the cable exit adapter 110 (not visible in FIG. 6) are aligned with the second inner guides 126 formed on the receptacle housing 120. The cable exit adapter 110 is then pressed into the receptacle housing 120 along the direction D shown in FIGS. 6 and 7. The cable exit adapter 110 is pressed into the receptacle housing 120 by sliding the first guides 114 along the second inner guides 126. At the same time, the outer surface of the retention hooks 113 slides along the second outer guides 127. A primary stop to the sliding of the cable exit adapter 110 along the direction D is given by the bottom portions 113A of the retention hooks 113 and the upper surface of the retention wall 123. In other words, when the bottom portions 113A of the retention hooks 113 contact the upper surface of the retention wall 123, further sliding of the cable exit adapter 110 is prevented. Moreover, in correspondence with the second extremity 126B of the second inner guides 126, a second stop portion or protruding portion is formed, which stops the sliding of the first guides 114 and, consequently, of the cable exit adapter 110, along the second inner guides 126. At the end of the sliding, the tab or cantilever 115 comes into contact with the seat 128 and a snap-fit connection is formed. The tab or cantilever 115 is snapped onto the seat 128 so as to provide a quick and stable engagement between the two components.

FIG. 7 schematically illustrates a front view of the cable exit adapter 110 and of the receptacle housing 120 during the assembly process. In FIG. 7, it is possible to see the first guides 114 which are aligned with the second complimentary guides 126 formed on the rear surface of the receptacle housing 120. After snapping of the cantilever or tab 115 onto the seat 128, the reciprocal position of the cable exit adapter 110 and of the receptacle housing 120 is fixed by the retention hooks 113, which are hooked on the retention wall 123 of the receptacle housing 120.

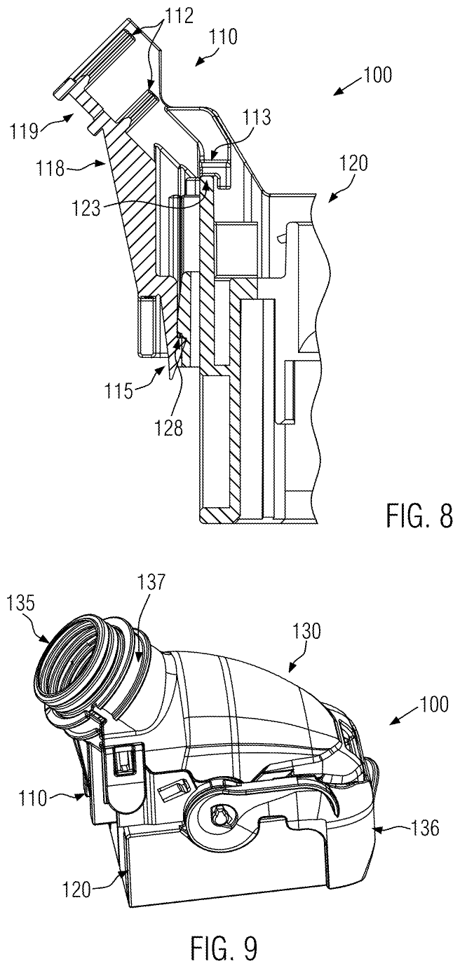

FIG. 8 schematically illustrates a side view of the modular cable exit assembly 100 in the assembled state. The first guides 114 of the cable exit adapter 110 are engaged with the second inner guides 126 of the receptacle housing 220. The tab or cantilever 115 is snapped onto the seat 128 of the receptacle housing 120 to form the snap-fit connection. The exit collar 119 protrudes from the receptacle housing 120 with a predefined declivity so as to guide the exit of the one or more cables connected to the terminals of the contact cavities 122. The retention hooks 113 are fixed on the retention wall 123 and the bottom portions 113A of the retention hooks 113, when in contact with the upper surface of the retention wall 123, form a primary stop for the position of the cable exit adapter 110.

It is to be understood that the cantilever 115 may be a multiple-use cantilever or a permanent connection cantilever.

In a multiple use snap-fit connection, the cantilever 115 may include a lever or pin of flexible material that can be pushed, in order to undo the snap-fit connection. This configuration is particularly advantageous because the cable exit adapter 110 is removable and, if needed, can be removed and replaced with a different cable exit adapter 210, 310 or 410 without changing the receptacle housing 120. In this way, the cable exit orientation can be varied without modifying the contacts of the receptacle housing 120.

According to an alternative configuration, a permanent snap-fit connection may be formed. In a permanent snap-fit connection, the cantilever 115 does not include any lever or pin and it cannot be pushed to undo the snap-fit connection. On the other hand, attempting to undo a permanent snap-fit connection can result in the piece breaking. In other words, if the snap-fit connection between the cable exit adapter 110 and the receptacle housing 120 is permanent, it is not possible to remove the cable exit adapter 110 without breaking the cable exit adapter 110 and/or the receptacle housing 120, thus compromising the electrical connection.

Finally, FIG. 9 schematically illustrates a configuration of the modular cable exit assembly 100 further including a cover 130 for covering the electrical terminals of the receptacle housing 120. A corrugated tube 135 is placed between the cable exit adapter 110 and the cover 130 so as to guide the exit of the cables. The corrugated tube 135 is kept in position by the retention ribs 112 shown for instance in FIG. 2B, or the corresponding retention ribs 212 and 312 of FIGS. 3 and 4. In order to ensure additional retention of the corrugated tube 135, a cable tie (not shown) may be placed around the cover 130 and the cable exit adapter 110. The outer ribs 137 may be used for guiding the cable tie during fixation. A lever 136 may be further used to mate the electrical connector of the modular cable exit assembly 100 to the counterpart (female/male connector, header . . . ).

Further modifications and variations of the embodiments described herein will be clear for the person skilled in the art. Therefore, the present description has to be considered as including all the modifications and/or variations, the scope of which is defined by the appended claims.

For instance, even if only the configuration and the orientation of the cable exit adapters 100, 200, 300 and 400 have been described in detail, it is to be understood that the cable exit adapter may have any shape, for instance flat or rounded or a combination thereon, and may form any angle with respect to the main body of the receptacle housing, for instance any angle included between 0° and 180° with respect to the rear surface of the receptacle housing.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A modular cable exit assembly comprising:
a receptacle housing including one or more contact cavities for electrical terminals configured to be connected to at least one cable, said receptacle housing including a coupling portion; and
a cable exit adapter including an exit collar for accommodating a portion of said at least one cable coming out of said receptacle housing, said cable exit adapter including a body;
wherein said body and said coupling portion are coupled by a snap-fit connection of at least one of said body and said coupling portion.

2. The modular cable exit assembly according to claim 1, wherein a plurality of first guides are formed on said body of said cable exit adapter and a plurality of second guides are formed on said coupling portion and said plurality of first guides is configured to be fit into said mating second guides.

3. The modular cable exit assembly according to claim 1, wherein said cable exit adapter includes one or more retention hooks suitable for securing said cable exit adapter to a retention wall of said receptacle housing.

4. The modular cable exit assembly according to claim 1, wherein said body of said cable exit adapter includes a cantilever and said coupling portion includes a seat and said cantilever is configured to be inserted into said seat.

5. The modular cable exit assembly according to claim 1, wherein said exit collar is slanted by an angle of 45° with respect to a plane passing through said coupling portion.

6. The modular cable exit assembly according to claim 1, wherein said exit collar is slanted by an angle of 90° with respect to a plane passing through said coupling portion.

7. The modular cable exit assembly according to claim 1, wherein said exit collar is parallel to a plane passing through said coupling portion.

8. The modular cable exit assembly according to claim 1, wherein said cable exit adapter is removably coupled to said receptacle housing.

9. The modular cable exit assembly according to claim 1, further comprising a cover element for covering said receptacle housing.

10. A method for assembling a modular cable exit assembly comprising:
providing a receptacle housing including one or more contact cavities for electrical terminals configured to be connected to at least one cable, said receptacle housing including a coupling portion;
providing a cable exit adapter including an exit collar for accommodating a portion of said at least one cable coming out of said receptacle housing, said cable exit adapter including a body;
assembling said receptacle housing and said cable exit adapter by coupling said body and said coupling portion by a snap-fit connection.

11. The method for assembling the modular cable exit assembly according to claim 10, further comprising aligning first guides of said cable exit adapter with mating second guides of said receptacle housing and sliding said first guides along said second guides during coupling of said body and said coupling portion.

12. The method for assembling the modular cable exit assembly according to claim 10, further comprising inserting a cantilever of said cable exit adapter into a seat of said coupling portion.
